(19) United States
(12) Patent Application Publication
(10) Pub. No.: US 2014/0254514 A1
(43) Pub. Date: Sep. 11, 2014

(54) Codebook Enchancement for Long Term Evolution (LTE)

(71) Applicant: Broadcom Corporation, Irvine, CA (US)

(72) Inventors: Amin Mobasher, Sunnyvale, CA (US); Louay Jalloul, San Jose, CA (US)

(73) Assignee: Broadcom Corporation, Irvine, CA (US)

(21) Appl. No.: 14/197,714

(22) Filed: Mar. 5, 2014

Related U.S. Application Data
(60) Provisional application No. 61/774,395, filed on Mar. 7, 2013.

(51) Int. Cl. H04B 7/04

(52) U.S. Cl. CPC H04B 7/0486
USPC 370/329

(57) ABSTRACT

Multiple input multiple output systems using a transmit precoder codebook designed for a four-transmitter (4Tx) antenna configuration are described. The 4Tx antenna configuration is an attractive option for base stations in cellular network environments and it is desirable to use a transmitter precoder codebook that provides sufficient granularity in typical operating scenarios, and to address various antenna configurations. In an embodiment, the transmit precoder codebook can be used for a variety of transmit antenna configurations including uniform linear antenna arrays, cross-polarized antenna arrays and uncorrelated antenna arrays. In another embodiment, the transmit precoder codebook is a two-component codebook, with a first precoder component signaled at a first rate and a second precoder component signaled at a second higher rate.

### CROSS-REFERENCE TO RELATED APPLICATIONS

The present application claims the benefit of U.S. Provisional Application No. 61/774,395, filed Mar. 7, 2013, which is incorporated herein by reference in its entirety.

### TECHNICAL FIELD

The present disclosure relates generally to multi-antenna transmit precoding, including a transmit precoder codebook for multi-antenna transmission.

### BACKGROUND

### Background Art

The wireless marketplace is witnessing ever-increasing throughput demands, despite the limitations of the available frequency bandwidth. To that end, modern wireless communication protocols have adopted the multiple-input multiple-output (MIMO) antenna approach in order to increase a network's capacity over that available in traditional single-input single-output (SISO) systems that use a single transmit and a single receive antenna. In a MIMO system, the system capacity is theoretically increased by the smaller of the number of transmit antennas and the number of receive antennas. The MIMO approach has been adopted by current generation wireless protocols (e.g., 3GPP Long Term Evolution (LTE)), and is also being actively considered by next generation wireless protocols.

To realize the theoretical MIMO capacity gains, communication systems require knowledge of the MIMO wireless channel. Based on this knowledge, the MIMO wireless system can use signal processing techniques to enhance the capacity. One of the signal processing techniques is precoding that transforms the transmitted data before the data is sent through the transmit antennas. Precoding is currently used in wireless standards such as 3GPP LTE and 3GPP LTE-Advanced.

Precoding may be implemented in a number of different ways. For example, complex routines can be used to analyze the instantaneous MIMO wireless channel and to output an appropriate (e.g., optimal) precoder at any point in time. However, one disadvantage of this approach is the overhead of feeding back the instantaneous MIMO channel state information (CSI) from receiver to transmitter.

An alternative approach is to use codebook-based precoding. Codebook-based precoding acknowledges the disadvantage of overhead of the CSI feedback by addressing the trade-off between MIMO system performance and the CSI feedback overhead. One codebook-based precoding approach relies on a set of codewords that are stored in the MIMO system. In such a system, the MIMO receiver feeds back an entry (e.g., in the form of a precoding matrix indicator (PMI)) in the codebook to indicate which codeword the transmitter should use. Different codebooks are used for different MIMO antenna configurations.

### BRIEF SUMMARY

Embodiments in this disclosure include a method that includes receiving, at a first communication device, a codebook entry indication from a second communication device, wherein the first communication device includes a four-antenna array with different antenna configurations including uniform linear antenna array, cross-polarized antenna array and uncorrelated antenna array. The method further includes accessing a codebook entry, using the codebook entry indication, in a codebook related to a multiple input multiple output (MIMO) system, the codebook being stored in a memory and having entries for rank 1 through 4, wherein the codebook is based on a matrix formed by multiplication of a first component matrix and a second component matrix, the first component matrix comprising discrete Fourier transform (DFT) vectors. The method further includes performing transmissions by the MIMO system using said codebook entry.

Embodiments in this disclosure also include a communication device that includes a processor and/or circuit that is configured to receive a codebook entry indication from a second communication device, wherein the communication device includes a four antenna array selected from a uniform linear antenna array, a cross-polarized antenna array and an uncorrelated antenna array. The processor and/or circuit is further configured to access a codebook entry, using the codebook entry indication, in a codebook related to a multiple input multiple output (MIMO) system, the codebook being stored in a memory and having entries for rank 1 through 4, wherein the codebook is based on a matrix formed by multiplication of a first component matrix and a second component matrix. The processor and/or circuit is further configured to perform transmissions by the MIMO system using said codebook entry.

### BRIEF DESCRIPTION OF THE DRAWINGS/FIGURES

The accompanying drawings, which are incorporated herein and form a part of the specification, illustrate the present disclosure and, together with the description, further serve to explain the principles of the disclosure and to enable a person skilled in the pertinent art to make and use the disclosure.

FIG. 1 illustrates an example MIMO environment in which embodiments can be implemented or practiced.

FIG. 2 illustrates an example communication device according to an embodiment.

FIG. 3 illustrates an exemplary feedback path for use in a precoding MIMO environment.

FIG. 4 illustrates an exemplary flowchart for a codebook entry indication method in a MIMO environment.

The present disclosure will be described with reference to the accompanying drawings. Generally, the drawing in which an element first appears is typically indicated by the leftmost digit(s) in the corresponding reference number.

### DETAILED DESCRIPTION OF THE INVENTION

For purposes of this discussion, the term “module” shall be understood to include at least one of software, firmware, and hardware (such as one or more circuits, microchips, processors, or devices, or any combination thereof), and any combination thereof. In addition, it will be understood that each module can include one, or more than one, component within an actual device, and each component that forms a part of the described module can function either cooperatively or independently of any other component forming a part of the module. Conversely, multiple modules described herein can represent a single component within an actual device. Further, components within a module can be in a single device or distributed among multiple devices in a wired or wireless manner.

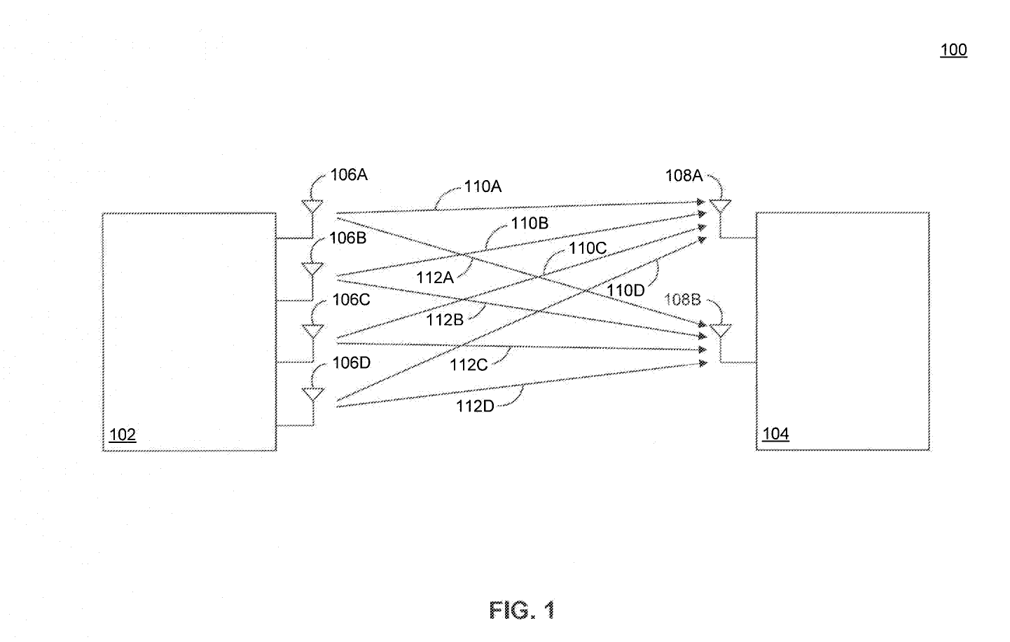

FIG. 1 illustrates an example MIMO environment 100 in which embodiments can be implemented or practiced. Example MIMO environment 100 is provided for the purpose of illustration only and is not limiting of embodiments. As shown in FIG. 1, example environment 100 includes a first communication device 102 and a second communication device 104 that can communicate wirelessly with each other. For the purpose of illustration only, communication device 102 is shown as having four antennas 106A-106D and communication device 104 is shown as having two antennas 108A and 10813.

In embodiments, communication devices 102 and 104 can be part of or can form a wireless communication network, including, without limitation, a cellular network, a Wireless Local Area Network (WLAN), and a Bluetooth® network. For example, communication devices 102 and 104 can be a base station and a user equipment (UE) respectively (or vice versa) in a cellular network. The cellular network can operate using existing 3G/4G cellular technology standards (e.g., Long Term Evolution (LTE), LTE—Advanced, Wideband Code Division Multiple Access (WCDMA), WiMAX, etc.) or future 5G cellular technology standards. Alternatively, communication devices 102 and 104 can be an Access Point (AP) and a WLAN client device respectively (or vice versa) in a WLAN network, or a master node and a slave node respectively (or vice versa) of a Bluetooth® connection.

MIMO techniques can be sub-divided into three categories, namely spatial multiplexing (SM), diversity coding, and beamforming. Spatial multiplexing splits a high-rate signal into multiple lower-rate streams, and each stream is transmitted from a different transmit antenna using the same frequency channel. If these streams arrive at the receiver antenna array with sufficiently different spatial signatures, the receiver can separate these streams to create parallel channels or streams. Spatial multiplexing can therefore increase channel capacity. The maximum number of spatial streams is limited by the lesser of the number of antennas at the transmitter and the number of antennas at the receiver. Spatial multiplexing can be used without a knowledge of transmit channel characteristics, but performance can be improved through a knowledge of the transmit channel characteristics.

Diversity coding is a technique that may be used when there is no knowledge of transmit channel information at the transmitter. In diversity coding, a single stream (unlike the multiple streams transmitted in spatial multiplexing) is transmitted. Diversity coding exploits the independent fading in the multiple antenna links to enhance signal diversity. Because there is no knowledge of the transmit channel characteristics, there is no beamforming or array gain when diversity coding is used.

Beamforming is a technique in which the same signal is emitted from multiple transmit antennas with appropriate weighting (phase and possible gain) applied to each antenna such that the signal power is maximized at the receiver input. Beamforming increases the signal gain from constructive combining, which thereby reduces multipath fading effects.

In an embodiment, communication device 102 can use antennas 106A-106D to transmit one or more data signals (data streams) to communication device 104. For example, in an embodiment, communication device 102 can use antennas 106A-106D to transmit respectively signals 110A-110D to communication device 104. In another embodiment, signals 110A-110D include the same data signal, and communication device 102 transmits signals 110A-110D simultaneously while pre-coding (applying an amplitude and/or phase scalar to) one or more of signals 110A-110D such that signals 110A-110D combine constructively at antenna 108A of communication device 104. Additionally, the pre-coding can be such that signals 110A-110D combine destructively or create a null at antenna 108B of communication device 104. The constructive combining of signals 110A-110D at antenna 108A (e.g., to maximize signal power) is known as beamforming as described above, and the amplitude/phase scalars applied to signals 110A-110D form a vector known as a transmit precoder. In example environment 100, a transmit precoder vector to transmit signals 110A-110D can be a 4×1 vector (rank 1), with one element (indicating the respective amplitude and/or phase scalar) for each of antennas 106A-106D.

In another embodiment, communication device 102 can use antennas 106A-106D to further transmit (simultaneously with and on the same frequency resources as used for the transmission of signals 110A-110D) respectively signals 112A-112D to communication device 104. In an embodiment, signals 112A-112D include the same data signal, and communication device 102 transmits signals 112A-112D simultaneously while pre-coding (applying an amplitude and/or phase scalar to) one or more of signals 112A-112D such that signals 112A-112D combine constructively at antenna 108B of communication device 104.

As for signals 110A-110D, a 4×1 transmit precoder is used to pre-code signals 112A-112D. As such, communication device 102 can use two 4×1 transmit precoders or a 4×2 (rank 2) transmit precoder to simultaneously transmit two data streams to communication device 104 on the same frequency resources.

Generally, in order to determine the appropriate transmit precoder(s) for transmission to communication device 104, communication device 102 must have knowledge of the channel(s) from communication device 102 to communication device 104. For example, in order to beamform at antenna 108A of communication device 104, the transmit precoder applied by communication device 102 must capture the 4×1 channel formed between antennas 106A-106D of communication device 102 and antenna 108A of communication device 104.

In practice, obtaining channel knowledge at communication device 102 may be inefficient. For example, in a cellular network environment, the downlink channel (from the base station to the UE) can be readily estimated at the UE. While the channel estimate can be signaled to the base station from the UE, such signaling can consume significant resources and can be undesirable. Instead, it is more efficient for the UE to compute and signal to the base station the transmit precoder(s) that enable beamforming or multi-stream transmission from the base station to the UE. Typically, this is done by signaling an index that specifies a transmit precoder from a finite set of transmit precoders (available at both the UE and the base station), also known as a transmit precoder codebook. The specified transmit precoder is the closest to the computed transmit precoder from within the transmit precoder codebook.

In the following, systems using a transmit precoder codebook designed for a four-transmitter (4Tx) antenna configuration (e.g., as in communication device 102) are described. The 4Tx antenna configuration is an attractive option for base stations in cellular network environments due to site-acquiring advantages and robust performance. As further described below, the transmit precoder codebook can be used for a variety of transmit antenna configurations. The transmit precoder codebook may have a high resolution to enable beamforming and/or nulling.

In an embodiment, the transmit precoder codebook is a two-component codebook, with a first precoder component signaled at a first rate and a second precoder component signaled at a second higher rate. In various embodiments, the first rate is a slower rate (i.e., higher period) than the second rate. For example, the first precoder component may be communicated from the UE to the base station every 10 ms, while the second component may be communicated from the UE to the base station every 1 ms. As such, the overhead required to signal a transmit precoder can be reduced since only a portion of the two-component codebook may be fed back every 1 ms. The first precoder component may correspond to wideband and/or long-term channel characteristics. The second precoder component may correspond to frequency-selective and/or short-term channel characteristics.

Feedback of the channel characteristics should be optimized to support common deployment scenarios, including various expected propagation conditions. For example, the codebook design should ideally accommodate frequently deployed antenna configurations, both in terms of number of antennas and the type and spacing of those antennas. For example, antenna configurations found in practice include uniform linear array antennas, cross-polarized antennas and uncorrelated antennas. In an embodiment, the codebook may contain entries that support these antenna configurations, namely uniform linear array antennas, cross-polarized antennas and uncorrelated antennas.

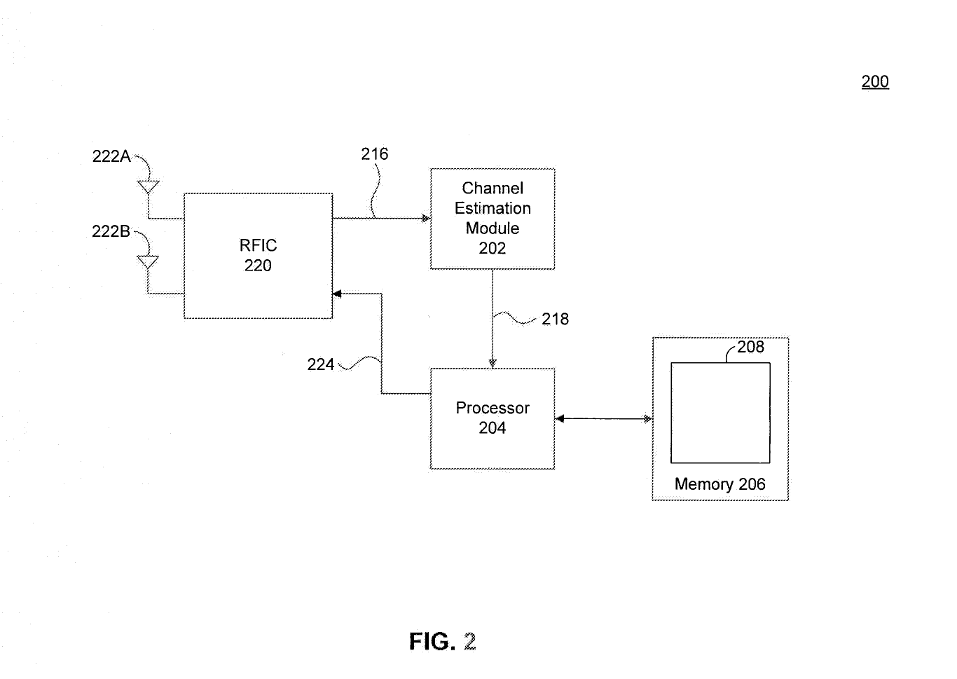

FIG. 2 illustrates an example communication device 200 in which embodiments can be implemented or practiced. Example communication device 200 is provided for the purpose of illustration only and is not limiting of embodiments. Example communication device 200 can be an embodiment of communication device 104, for example. As such, example communication device 200 can be configured to receive one or more data streams from another communication device. For example, example communication device 200 can be a UE configured to receive one or more data streams from a base station. As further described below, example communication device 200 can assist the other communication device in order to beamform the one or more data streams to communication device 200, by selecting and signaling appropriate transmit precoders to the other communication device.

As shown in FIG. 2, example communication device 200 includes, without limitation, a transmitter comprised of a plurality of antennas 222A-222B and a radio frequency integrated circuit (RFIC) 220; a channel estimation module 202; a processor 204; and a memory 206. In an embodiment, memory 206 is configured to store a transmit precoder codebook 208. Transmit precoder codebook 208 includes a plurality of transmit precoders. In an embodiment, communication device 200 can signal a transmit precoder from the plurality of transmit precoders to the other communication device. The other communication device can use the signaled transmit precoder to beamform transmitted signals to example communication device 200. Communication device 200 can signal a transmit precoder periodically to the other communication device or when changes in the channel from other communication device is detected.

In an embodiment, communication device 200 can receive one or more signals from the other communication device using antennas 222A-222B. In other embodiments, communication device 200 can have more or less than two antennas. The signals received by antennas 222A-222B are processed by RFIC 220, which may filter, down-convert, and digitize the received signals and then provide the signals in the form of a baseband signal 216 to channel estimation module 202. In other embodiments (not illustrated in FIG. 2), RFIC 220 may provide baseband signal 216 to processor 204, which may perform demodulation of baseband signal 216 to retrieve the information contained therein.

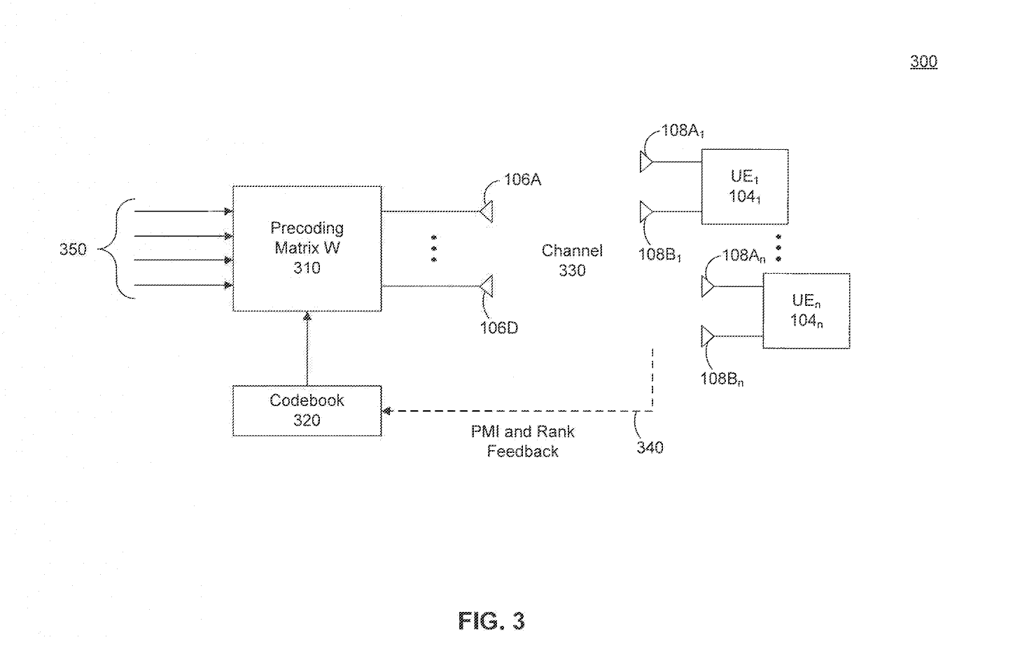

FIG. 3 illustrates the use of a MIMO precoding technique, where embodiments of the present disclosure may be practiced. Referring to FIG. 3, the transmitted data is divided into multiple transmit streams 350, whereby they are precoded by precoding matrix W 310 before transmission by antennas 106A-106D. The transmitted streams pass through channel 330 before being received by antennas 108A-108B of one or more of UEs 104. Each communication device 104 may have one or more antennas 108. In an exemplary fashion and without limitation, FIG. 3 illustrates n communication devices 104₁ through 104ₙ. Communication device 104₁ has two antennas 108A₁ and 108B₁. Similarly, communication device 104ₙ has two antennas 108Aₙ and 108Bₙ. In Long Term Evolution (LTE), communication device 102 is referred to a base station or eNodeB, and communication device 104 is referred to as user equipment (UE). The number of transmit streams is referred to as a transmission rank. Feedback on the channel characteristics is provided by communication devices 104 back to communication device 102 in the form of a rank indication (RI) and a precoding matrix indicator (PMI). A precoding matrix indicator (PMI) is an indication of which codebook entry should be used in the codebook 320.

In codebook based precoding, codebook 320 is provided for the base station (communication device 102, e.g., eNodeB) and for all user equipment (e.g., UE 104). Each user equipment 104 can then choose a precoder (codebook entry) from the codebook based on different criteria. For example, criteria may include maximization of performance or minimization of interference. The choice of codebook entry is the PMI that is returned via the feedback path 340.

As noted above, MIMO schemes are used in Evolved Universal Terrestrial Radio Access (E-UTRA) systems, including Long Term Evolution (LTE) systems. The Third Generation Partnership Project (3GPP) E-UTRA standards specify MIMO schemes for use by E-UTRA User Equipment (UE) and base stations (eNodeB). These schemes are described, for example, in 3GPP Technical Specification 36.211, entitled “LTE; Evolved Universal Terrestrial Radio Access (E-UTRA); Physical channels and modulation (3GPP TS 36.211 version 11.4.0 Release 11),” October 2013, which is incorporated herein by reference. For example, section 6.3.4 of this specification defines precoding schemes that map data streams (also referred to as spatial layers) onto up to four transmit antenna ports. The evolving LTE specifications contemplate the use of up to eight transmit antenna ports.

The approach for feedback of channel state information is described, for example, in 3GPP Technical Specification 36.213, entitled “LTE; Evolved Universal Terrestrial Radio Access (E-UTRA); Physical layer procedures (3GPP TS 36.213 version 11.4.0 Release 11),” October 2013, which is incorporated herein by reference. For example, section 7.2 of this specification defines the approach by which UEs report channel state information back to the base station (eNodeB).

As can be readily noted in the above-cited technical specifications, LTE has employed codebooks in LTE Releases 8 and onward for various deployment scenarios. However, usage of these codebooks in the 4-transmitter case has identified a number of problems, including a lack of sufficient granularity in typical operating scenarios, as well the need to address additional antenna configurations. In seeking to improve the codebook to address these issues, an examination of codebooks used in these prior releases is useful, both to understand their shortcomings, as well as to provide compatibility of the improved codebook with the prior code books.

By way of background, Table 1 below shows a codebook for LTE Release 8 for the 4-antenna configuration, which was also inherited by later LTE Releases up to LTE Release 11. As can be readily noted, the LTE Release 8 codebook for the 4-antenna configuration has a total of 16 entries:

TABLE 1
LTE Release 10: 4-Antenna Codebook Design

| 1 | 2 | 3 | 4 | 5 | 6 | 7 | 8 |
|---|---|---|---|---|---|---|---|
| $[ \begin{matrix}1 \\ 1 \\ 1 \\ 1\end{matrix} ]$ | $[ \begin{matrix}1 \\ j \\ - 1 \\ - j\end{matrix} ]$ | $[ \begin{matrix}1 \\ - 1 \\ 1 \\ - 1\end{matrix} ]$ | $[ \begin{matrix}1 \\ - j \\ - 1 \\ j\end{matrix} ]$ | $[ \begin{matrix}1 \\ {e}^{j \frac{π}{4}} \\ j \\ {e}^{j 3 \frac{π}{4}}\end{matrix} ]$ | $[ \begin{matrix}1 \\ {e}^{j 3 \frac{π}{4}} \\ j \\ {e}^{j \frac{π}{4}}\end{matrix} ]$ | $[ \begin{matrix}1 \\ {e}^{j 5 \frac{π}{4}} \\ j \\ {e}^{j 7 \frac{π}{4}}\end{matrix} ]$ | $[ \begin{matrix}1 \\ {e}^{j 7 \frac{π}{4}} \\ j \\ {e}^{j 5 \frac{π}{4}}\end{matrix} ]$ |
| 9 | 10 | 11 | 12 | 13 | 14 | 15 | 16 |
| $[ \begin{matrix}1 \\ 1 \\ - 1 \\ - 1\end{matrix} ]$ | $[ \begin{matrix}1 \\ j \\ 1 \\ j\end{matrix} ]$ | $[ \begin{matrix}1 \\ - 1 \\ - 1 \\ 1\end{matrix} ]$ | $[ \begin{matrix}1 \\ - j \\ 1 \\ - j\end{matrix} ]$ | $[ \begin{matrix}1 \\ 1 \\ 1 \\ - 1\end{matrix} ]$ | $[ \begin{matrix}1 \\ 1 \\ - 1 \\ 1\end{matrix} ]$ | $[ \begin{matrix}1 \\ - 1 \\ 1 \\ 1\end{matrix} ]$ | $[ \begin{matrix}1 \\ - 1 \\ - 1 \\ - 1\end{matrix} ]$ |

These codebook entries are applicable to various antenna configurations, as can be understood by using the following insight for each type of antenna configuration. For each of the antenna configurations of interest, the use of insight leads to a different representation for codebook entries that would be suitable for those antenna configurations. For example, the following parameterized column vector provides a suitable rank-1 precoder for use with uniform linear array antennas (ULA) in the 4-antenna configuration, where θ can be uniformly quantized from (0,2π). The parameter, θ, captures the angle of departure (AoD) of the dominant signal path to the uniform linear array antennas. The 4 rows of the column vector are associated with the 4 antennas, while the amount of quantization is set by the numbers of entries in the codebook that are applicable to the uniform linear array antenna configuration.

$${W}_{ULA} ( θ ) = [ \begin{matrix}1 \\ {e}^{j θ} \\ {e}^{j2 θ} \\ {e}^{j 3 θ}\end{matrix} ]$$

Similarly, the following parameterized column vector provides a suitable rank-1 precoder for use with a 4-antenna configuration that uses cross-polarized antennas, where θ can be uniformly quantized from (0,2π) and c ε {1,−1,j,−j}. Again, the parameter, θ, captures the angle of departure (AoD) of the, dominant signal path to the cross-polarized antennas. The parameter, c, captures the phase adjustment associated with the two pairs of cross-polarized antennas that typically makes up the 4-antenna cross-polarized antenna configuration. As with the uniform linear array, the 4 rows of the column vector are associated with the 4 antennas, while the amount of quantization is set by the numbers of entries in the codebook that are applicable to the cross-polarized array antenna configuration.

$${W}_{XPOL} ( θ , c ) = [ \begin{matrix}1 \\ {e}^{j θ} \\ c \\ c {e}^{j θ}\end{matrix} ]$$

Similarly, the following parameterized column vector provides a suitable rank-1 precoder for use with a 4-antenna configuration with uncorrelated antennas, where θ₁,θ₂ can be uniformly quantized from [0,2π) and c ε {1,−1,j,−j}. Here, the parameters, θ₁ and θ₂, capture the angle of departures (AoD) of the dominant signal path to two of the four antennas, with the parameter, c, capturing the phase adjustment between the first two antennas and the second two antennas in the 4-antenna uncorrelated configuration. As with the uniform linear array, the 4 rows of the column vector are associated with the 4 antennas, while the amount of quantization is set by the numbers of entries in the codebook that are applicable to the uncorrelated array antenna configuration.

$${W}_{UNCORR} ( {θ}_{1} , {θ}_{2} , c ) = [ \begin{matrix}1 \\ {e}^{j {θ}_{1}} \\ c \\ c {e}^{j {θ}_{2}}\end{matrix} ]$$

Based on the insights provided by the above mathematical representations associated with each type of antenna, one can ascertain which codewords from the code book in Table 1 are suitable for use with each type of antenna. For example, in Table 1, there are 8 codewords, namely codewords 1 through 8, that are suitable for use with uniform linear array antennas, where

$$θ = \frac{2 π n}{{2}^{{B}_{1}}} .$$

In this case, the quantization is three bits (i.e., B₁=3).

Similarly, in Table 1, there are 12 code-words, namely codewords 1 through 12, that are suitable for use with cross-polarized antennas. In this case, the parameters take on the following values of

$$θ = \frac{2 π n}{8}$$

when n is even, and c=±1; however, when n is odd c=jⁿ. The parameter values are illustrated in Table 2 below.

TABLE 2
Cross-polarization Codewords in LTE Release 10

| | 1 | 2 | 3 | 4 | 5 | 6 | 7 | 8 | 9 | 10 | 11 | 12 |
|---|---|---|---|---|---|---|---|---|---|---|---|---|
| θ | $\frac{2 π0}{8}$ | $\frac{2 π2}{8}$ | $\frac{2 π4}{8}$ | $\frac{2 π6}{8}$ | $\frac{2 π1}{8}$ | $\frac{2 π3}{8}$ | $\frac{2 π5}{8}$ | $\frac{2 π7}{8}$ | $\frac{2 π0}{8}$ | $\frac{2 π2}{8}$ | $\frac{2 π4}{8}$ | $\frac{2 π6}{8}$ |
| c | 1 | −1 | 1 | −1 | j | −j | j | −j | −1 | 1 | −1 | 1 |

Finally, in Table 1, the last four codewords, namely codewords 13 through 16, are suitable for use in the uncorrelated case, with θ₁, θ₂ and c taking on the values shown below in Table 3.

TABLE 3
Uncorrelated Codewords in LTE Release 10

| | 13 | 14 | 15 | 16 |
|---|---|---|---|---|
| θ₁ | $\frac{2 π0}{8}$ | $\frac{2 π0}{8}$ | $\frac{2 π4}{8}$ | $\frac{2 π4}{8}$ |
| θ₂ | $\frac{2 π4}{8}$ | $\frac{2 π4}{8}$ | $\frac{2 π0}{8}$ | $\frac{2 π0}{8}$ |
| c | 1 | −1 | 1 | −1 |

In addition to associating each of the codewords with the appropriate antenna configurations, the mathematical representations associated with each of the three types of antenna configurations may be generalized to cover all three situations, as follows. The following generalized representation of the rank-1 LTE Release 8 codewords is a function of three parameters, n1, n2 and α, where these three parameters have the values shown in Table 4. In addition, the generalized representation decomposes the codeword structure into two components that are multiplied together to form the overall 4-row column vector codeword for rank 1 precoding. The first component is a 4×4 diagonal matrix that is a function of the parameter n₁. The second component is a 4-row column vector that is a function of the two parameters, n₂ and α.

$$W ( {n}_{1} , {n}_{2} , α ) = diag ( [ \begin{matrix}1 \\ {e}^{j \frac{2 π {n}_{1}}{8}} \\ {e}^{j2 \frac{2 π {n}_{1}}{8}} \\ {e}^{j3 \frac{2 π {n}_{1}}{8}}\end{matrix} ] ) [ \begin{matrix}1 \\ 1 \\ {e}^{j \frac{2 π {n}_{2}}{4}} \\ {αe}^{j \frac{2 π {n}_{2}}{4}}\end{matrix} ]$$

TABLE 4
Parameter Values for New Generalized Representation for
Codewords in LTE Release 10

| | 1 | 2 | 3 | 4 | 5 | 6 | 7 | 8 | 9 | 10 | 11 | 12 | 13 | 14 | 15 | 16 |
|---|---|---|---|---|---|---|---|---|---|---|---|---|---|---|---|---|
| n₁ | 0 | 2 | 4 | 6 | 1 | 3 | 5 | 7 | 0 | 2 | 4 | 6 | 0 | 0 | 4 | 4 |
| n₂ | 0 | 0 | 0 | 0 | 0 | 0 | 0 | 0 | 2 | 2 | 2 | 2 | 0 | 2 | 0 | 2 |
| α | 1 | 1 | 1 | 1 | 1 | 1 | 1 | 1 | 1 | 1 | 1 | 1 | −1 | −1 | −1 | −1 |

Using the insight provided by this new generalized representation of the codewords used in LTE Release 8, an extension of the codewords suitable to meet the additional objectives of later releases of LTE can be formulated.

As a first step, the one-component codebook structure W in LTE Release 8 can be subdivided into the two-component codebook structure of W₁ and W₂ for different antenna configurations, where W=W₁W₂, and W₁ corresponds to long term and/or wideband channel properties, and W₂ corresponds to short-term and narrowband channel estimation. The W₁ and W₂ sub-codebooks (i.e., the individual component matrices) can be designed such that the overall codebook, W, is optimized for different antenna configurations. For example, in an embodiment, the two-stage codebook is proposed to achieve enhanced spatial granularity of precoder matrix indicator (PMI) feedback for various antenna configurations. In various embodiments, W₁ can be represented by B bits and W₂ can be represented by B₂ bits.

At least three embodiments can be formulated using the above principles and insight. To provide a framework for a discussion of these embodiments, the overall precoder of rank r can be constituted as:

$$W = {W}_{1} {W}_{2} = diag ( v ) \times \frac{1}{\sqrt{r}} {M}_{r}$$

where the overall precoder W is a 4×r unitary precoding matrix, and W1 and W₂ (the two component matrices) are defined as follows:

W₁=diag(v)

where 17 is a 4×1 discrete Fourier transform (DFT) vector corresponding to the Angle of Departure (AoD) of the dominant signal path, and is defined below:

$$v ∈ \{ \frac{1}{2} [ \begin{matrix}1 & {e}^{j \frac{2 π {n}_{1}}{{2}^{{B}_{1}}}} & {e}^{j2 \frac{2 π {n}_{1}}{{2}^{{B}_{1}}}} & {e}^{j3 \frac{2 π {n}_{1}}{{2}^{{B}_{1}}}}\end{matrix} ] , {n}_{1} = 0 , … , {2}^{{B}_{1}} - 1 \}$$

and assuming that B₁ bits are available for a representation of W₁, the quantization for θ in V can be defined as

$$θ = \frac{2 π}{{2}^{{B}_{1}}} .$$

W₂ is defined as follows:

W₂=1/\sqrt{r}×Mᵣ

and Mᵣ is a 4×r matrix, which contains the refined information of channel properties. “Refined information” in the context of this disclosure means a refinement of the representation provided by another component, e.g., W₁. Thus, for example, W₁ may capture the long-term representation of a channel characteristic, while W₂ may capture the short-term variations (e.g., a refinement of the long-term representation) of the channel characteristic. Such refined information includes such effects as (a) the differences in channel properties between two ULA groups, (b) the difference between the overall precoder with W₁ for high correlated channels, and (c) similar effects. For a rank of 1 (i.e., r=1), Mᵣ is defined as follows:

$${M}_{r} = [ \begin{matrix}1 \\ 1 \\ {e}^{j \frac{2 π {n}_{2}}{{2}^{{B}_{2} - 1}}} \\ {αe}^{j \frac{2 π {n}_{2}}{{2}^{{B}_{2} - 1}}}\end{matrix} ] , {n}_{2} = 0 , … , {2}^{{B}_{2} - 1} - 1 , α = \pm 1$$

In one embodiment of the present disclosure, 8 bits can be used for feedback of the selected codebook entry, and the 8 bits can be split equally between the two components, W₁ and W₂, of the codewords. In such an embodiment, B₁=B₂=4 bits (In Mᵣ 1 bit is required for considering α). Note that the LTE Release 8 codebook can be considered a special case of this two-component embodiment, where B₂=B₁=3.

The mathematics of this codebook embodiment can be further understood as follows. Elaborating the elements of the matrix elements yields:

$$\begin{matrix}W = {W}_{1} {W}_{2} \\ = \frac{1}{2} [ \begin{matrix}1 & 0 & 0 & 0 \\ 0 & {e}^{j \frac{2 π {n}_{1}}{{2}^{{B}_{1}}}} & 0 & 0 \\ 0 & 0 & {e}^{j2 \frac{2 π {n}_{1}}{{2}^{{B}_{1}}}} & 0 \\ 0 & 0 & 0 & {e}^{j3 \frac{2 π {n}_{1}}{{2}^{{B}_{1}}}}\end{matrix} ] [ \begin{matrix}1 \\ 1 \\ {e}^{j \frac{2 π {n}_{2}}{{2}^{{B}_{1} - 1}}} \\ {αe}^{j \frac{2 π {n}_{2}}{{2}^{{B}_{1} - 1}}}\end{matrix} ] \\ = \frac{1}{2} [ \begin{matrix}( \begin{matrix}1 \\ {e}^{j \frac{2 π {n}_{1}}{{2}^{{B}_{1}}}}\end{matrix} ) \\ {e}^{j \frac{2 π \overbrace{( {n}_{2} + {n}_{1} )}^{m}}{{2}^{{B}_{1} - 1}}} ( \begin{matrix}1 \\ {αe}^{j \frac{2 π {n}_{1}}{{2}^{{B}_{1}}}}\end{matrix} )\end{matrix} ] ,\end{matrix} \qquad ( 1 )$$

where n₁=0, . . . , 2^{B}^{₁}−1, m=0, . . . , 2^{B}^{₁}⁻¹−1,α=±1.

Various terms in the above expansion can be interpreted as follows.

$${e}^{j \frac{2 π {n}_{1}}{{2}^{{B}_{1}}}}$$

can be considered as beam shift of one polarization that is represented within the W₁ long term and/or wideband DFT beam feedback.

$${e}^{j \frac{2 π m}{{2}^{{B}_{1} - 1}}}$$

can be considered as the co-phasing factor between the two polarizations.

α is the unary sign operator.

As mentioned above, it is desirable that codebook embodiments are compatible with the 4Tx codebook of LTE Release 10, while supporting many antenna configurations (the same as the LTE Release 8 or LTE Release 10 codebook). As noted above, various embodiments meet these requirements since they are compatible and support closely spaced or widely spaced uniform linear antennas (ULA), cross-polarized antennas (XPOL), and the uncorrelated antenna case. In the context of this disclosure, the uncorrelated antenna case includes both uncorrelated antenna configurations, as well as environmental conditions that lead to receipt of uncorrelated signals by the MIMO receiver.

A feature of the codebook embodiments discussed herein is the support for uncorrelated antenna configuration by introducing α=±1 in our designed codebook as it provides a robust design that performs well across both closely spaced and widely spaced cross-polarized antennas. In addition, it ensures that the codebook is robust in the presence of Timing Alignment Error (TAE), or in a widely-spaced antenna configuration.

The above two-component codebook embodiment representation described the W₁ component of the overall codebook W as a diagonal-based matrix. However, in an alternative embodiment, the W₁ component of the overall codebook W may also be expressed as a block-diagonal based codebook. In fact, these are two equivalent representations and may be used interchangeably. The equivalence of the representation is shown below.

For ease of explanation and without loss of generality, one may assume the unary sign operator α=1. In equation (1), an embodiment of the codebook was represented as:

$$\begin{matrix}W = {W}_{1} {W}_{2} \\ = \frac{1}{2} [ \begin{matrix}( \begin{matrix}1 \\ {e}^{j \frac{2 π {n}_{1}}{{2}^{{B}_{1}}}}\end{matrix} ) \\ {e}^{j \frac{2 π m}{{2}^{{B}_{1} - 1}}} ( \begin{matrix}1 \\ {αe}^{j \frac{2 π {n}_{1}}{{2}^{{B}_{1}}}}\end{matrix} )\end{matrix} ] ,\end{matrix} \qquad ( 2 )$$

The diagonal W₁ based codebook can be reformulated with block-diagonal based W₁ using a similar approach to the codebook design approach used for 8 transmit antennas in LTE Release 10. This approach captures all DFT beam shift channel characteristics into W₁, while W₂ is designed to capture the beam selection capability. Consequently, using this formulation, the block-diagonal based codebook structure can be formed equivalently using the following general formulation:

$$W = [ \begin{matrix}{X}_{n} & 0 \\ 0 & {X}_{n}\end{matrix} ] \cdot [ \begin{matrix}{e}_{{r}_{1}} \\ {q}_{2} {e}_{{r}_{2}}\end{matrix} ] , \qquad ( 3 )$$

where r₁, r₂ ε {1, . . . , 4},

$${q}_{2} = {e}^{j \frac{2 π m}{{2}^{{B}_{1} - 1}}}$$

and eᵢ is defined to be a selection vector of zeroes and a “1” in the i^{th} row.

In this alternative representation,

$${X}_{n} = [ \begin{matrix}1 & 1 & … & 1 \\ {q}_{1}^{{a}_{1 , n}} & {q}_{1}^{{a}_{2 , n}} & … & {q}_{1}^{{a}_{{C}_{R , n}}}\end{matrix} ]$$

which is a 2×C_{R} sized matrix with discrete Fourier transform (DFT) columns for n=0,1, 2, . . . , N₁−1, where N₁=16 (total number entries of W₁),

$${q}_{1} = {e}^{j \frac{2 π}{{2}^{{B}_{1}}}} ,$$

and 2^{B}^{₁} is granularity of beam of W₁. For each block matrix Xₙ, C_{R,n} is the total number of beams and α_{i,n} can be any integer number. Note that this formulation is a general formulation and therefore the previous representation fits within this general formulation. By “fit,” it is meant that values of unknown parameters such as α_{i,n} can be found to match the previous representation. In other words, the previous representation is merely a special case of the more general formulation, using the “matched” values of unknown parameters such as α_{i,n}.

Thus, the diagonal based codebook representation is mathematically equivalent to a block-diagonal based codebook representation. The beam selection in the block-diagonal based codebook can be converted to a finer beam shift in the diagonal-based codebook. Note that the block-diagonal representation in (3) is an example of the re presentation. As recognized by one of ordinary skill in the art, the same codeword can be represented by many different combinations of r₁, r₂, m, and n₁.

The design principle of the proposed codebook in (1) is to support a variety of antenna array configurations with a single unified codebook structure without significantly increasing feedback overhead, such as closely spaced CLA/ULA and widely spaced CLA/ULA. One important factor in this design is parameter α in which enables the codebook to better perform in the uncorrelated cases (wide antenna separation and small timing advance error or TAE).

In order to capture α in equation (2), in the block-diagonal representation of (3), it is necessary to make sure that if

$$[ \begin{matrix}1 \\ {q}_{1}^{k}\end{matrix} ]$$

is one of the columns of the matrix Xₙ,

$$[ \begin{matrix}1 \\ - {q}_{1}^{k}\end{matrix} ]$$

or equivalently

$$[ \begin{matrix}1 \\ {q}_{1}^{k + 16}\end{matrix} ] ,$$

is also one of the columns of Xₙ. This is of particular importance, since the same W₁ codebook is assumed for rank 1 and rank 2 feedback. One such example would be

$${W}_{1} = [ \begin{matrix}{X}_{n} & 0 \\ 0 & {X}_{n}\end{matrix} ] where n = 0 , 1 , … , 15 \\ {X}_{n} = [ \begin{matrix}1 & 1 & 1 & 1 \\ {q}_{1}^{n} & {q}_{1}^{n + 8} & {q}_{1}^{n + 16} & {q}_{1}^{n + 24}\end{matrix} ] where {q}_{1} = {e}^{j2π / 32} \qquad ( 4 )$$

where C_{R,n}=4, α_{l,n}=n+8(l−1)

For rank 1, one example for W₂ would be a set of 16 vectors of size 8×1

$${W}_{2 , n} ∈ \{ \frac{1}{\sqrt{2}} [ \begin{matrix}Y \\ α ( i ) Y\end{matrix} ] , \frac{1}{\sqrt{2}} [ \begin{matrix}Y \\ jα ( i ) Y\end{matrix} ] , \frac{1}{\sqrt{2}} [ \begin{matrix}Y \\ - α ( i ) Y\end{matrix} ] , \frac{1}{\sqrt{2}} [ \begin{matrix}Y \\ - jα ( i ) Y\end{matrix} ] \} \qquad ( 5 )$$

and Y=e₁ ε{e₁, e₂, e₃, e₄} and α(i)=q₁²⁽ⁱ⁻¹⁾;

The above analysis focused on embodiments for a rank of 1. In a similar manner, rank 2 codeword embodiments can be designed similar to the codebook design scheme for 8TX in LTE Release 10. An example that includes α=−1 may include:

$${W}_{2 , n} ∈ \{ \frac{1}{2} [ \begin{matrix}{Y}_{1} & {Y}_{2} \\ {Y}_{1} & - {Y}_{2}\end{matrix} ] , \frac{1}{2} [ \begin{matrix}{Y}_{1} & {Y}_{2} \\ j {Y}_{1} & - j {Y}_{2}\end{matrix} ] \} ( {Y}_{1} , {Y}_{2} ) ∈ \{ ( {e}_{1} , {e}_{1} ) , ( {e}_{2} , {e}_{2} ) , ( {e}_{3} , {e}_{3} ) , ( {e}_{4} , {e}_{4} ) \} \\ and \\ {W}_{2 , n} ∈ \{ \frac{1}{2} [ \begin{matrix}{Y}_{1} & {Y}_{2} \\ {Y}_{2} & - {Y}_{1}\end{matrix} ] , \} ( {Y}_{1} , {Y}_{2} ) ∈ \{ ( {e}_{1} , {e}_{3} ) , ( {e}_{2} , {e}_{4} ) , ( {e}_{3} , {e}_{1} ) , ( {e}_{4} , {e}_{2} ) \} \qquad ( 6 )$$

In a further embodiment, the overall precoder of rank r can be constituted as

$$W = {W}_{1} {W}_{2} = diag ( v ) \times \frac{1}{\sqrt{r}} {M}_{r} \qquad ( 7 )$$

where the terms are defined as follows:

The overall precoder W is a 4×r unitary precoding matrix, w₁=diag(v), and v is a 4×1 DFT vector corresponding to AoD of the dominant path. Assuming we have B₁ bits for W₁, we can define the quantization for θ to be

$$θ = \frac{2 π}{{2}^{{B}_{1}}} .$$

$$v ∈ \{ \frac{1}{2} [ \begin{matrix}\begin{matrix}1 & {e}^{j \frac{2 π {n}_{1}}{{2}^{{B}_{1}}}} & {e}^{j2 \frac{2 π {n}_{1}}{{2}^{{B}_{1}}}}\end{matrix} & {αe}^{j3 \frac{2 π {n}_{1}}{{2}^{{B}_{1}}}}\end{matrix} ] , {n}_{1} = 0 , … , {2}^{{B}_{1}} - 1 , α = \pm 1 \}$$

W₂=1/\sqrt{r}×Mᵣ, and Mᵣ is a 4×r matrix, which contains the refined information of channel properties, such as the channel properties between two ULA groups, and the difference between the overall precoder with W₁ for high correlated channels. For r=1, Mᵣ is defined as follows:

$${M}_{r} = [ \begin{matrix}1 \\ {e}^{j \frac{2 π {n}_{1}}{{2}^{{B}_{1} + 1}}} \\ {e}^{j \frac{2 π {n}_{2}}{{2}^{{B}_{2}}}} \\ {e}^{j \frac{2 π {n}_{2}}{{2}^{{B}_{2}}}} {e}^{j \frac{2 π {n}_{1}}{{2}^{{B}_{1} + 1}}}\end{matrix} ] , {n}_{1} = 0 , 1 , {n}_{2} = 0 , … , {2}^{{B}_{2}} - 1 ,$$

Here, in an embodiment, B₂=B₁=3 bits. Note that the Release 8 codebook can be considered a special case of this structure with B₂=B₁=3 and n₁=0.

In a further embodiment, the overall precoder of rank r can be constituted as

$$W = {W}_{1} {W}_{2} = diag ( v ) \times \frac{1}{\sqrt{r}} {M}_{r} \qquad ( 8 )$$

Where the overall precoder W is a 4×r unitary precoding matrix, W₁=diag(v), and v is a 4×1 DFT vector corresponding to AoD of the dominant path. Assuming we have B₁ bits for W₁, the quantization for θ may be defined to be

$$θ = \frac{2 π}{{2}^{{B}_{1}}} .$$

$$v ∈ \{ \frac{1}{2} [ \begin{matrix}\begin{matrix}1 & {e}^{j \frac{2 π {n}_{1}}{{2}^{{B}_{1}}}} & {αe}^{j2 \frac{2 π {n}_{1}}{{2}^{{B}_{1}}}}\end{matrix} & {αe}^{j3 \frac{2 π {n}_{1}}{{2}^{{B}_{1}}}}\end{matrix} ] , {n}_{1} = 0 , … , {2}^{{B}_{1}} - 1 , α = \pm 1 \}$$

W₂=1/\sqrt{r}×Mᵣ, and Mᵣ is a 4×r matrix, which contains the refined information of channel properties, such as the channel properties between two ULA groups, and the difference between the overall precoder with W₁ for high correlated channels. For r=1, we propose

$${M}_{r} = [ \begin{matrix}1 \\ {e}^{j \frac{2 π {n}_{1}}{{2}^{{B}_{1} + 1}}} \\ {e}^{j \frac{2 π {n}_{2}}{{2}^{{B}_{2} - 1}}} \\ {βe}^{j \frac{2 π {n}_{2}}{{2}^{{B}_{2} - 1}}} {e}^{j \frac{2 π {n}_{1}}{{2}^{{B}_{1} + 1}}}\end{matrix} ] , \\ {n}_{1} = 0 , 1 , {n}_{2} = 0 , … , {2}^{{B}_{2} - 1 } - 1 , β = \pm 1$$

Here, in an embodiment, B₂=B₁=3 bits.

In a further embodiment, a Rank-2 codebook design is also similar to the codebook design scheme for 8TX in LTE Release 10, i.e.,

$$M = [ \begin{matrix}X & X \\ Y & - Y\end{matrix} ] ,$$

where X and Y are the first two elements and the second two elements of the rank-1 matrix M defined in any of the embodiments 1, 2, or 3, respectively. For rank r=3 or 4, the precoder is selected from LTE Release 10 4Tx rank-r codebook.

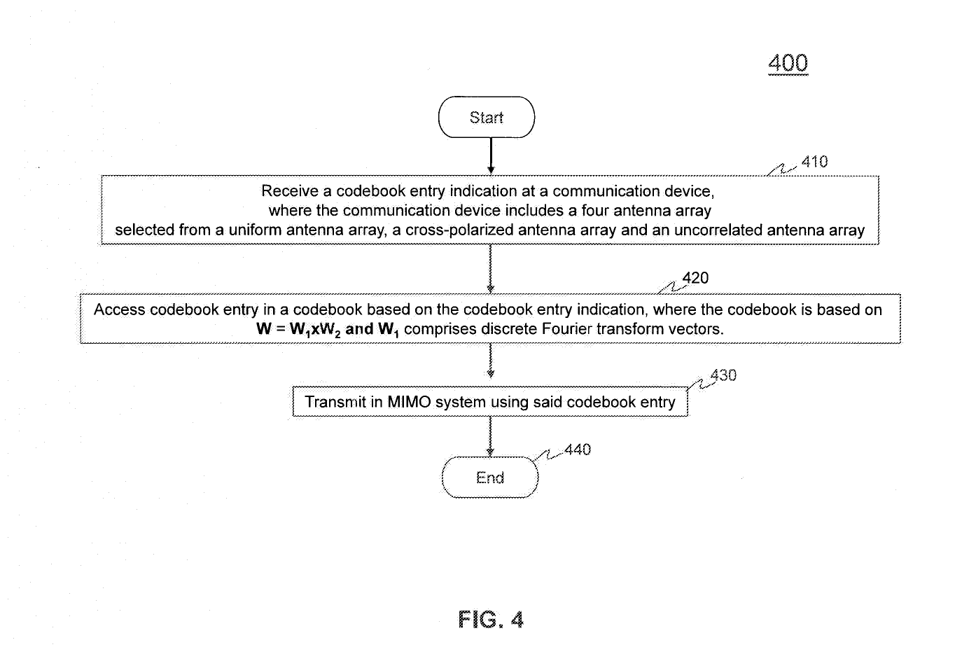

FIG. 4 provides a flowchart of a method 400 of using a codebook entry, according to an embodiment of the current disclosure.

The process begins at step 410. In step 410, a codebook entry indication is received at a communication device, where the communication device includes a four antenna array selected from a uniform antenna array, a cross-polarized antenna array and an uncorrelated antenna array. In an embodiment, communication device 120 (e.g., a base station, eNodeB) receives, a precoding matrix indicator (PMI) from communication device 104 via feedback path 340.

In step 420, a codebook entry is accessed in a codebook based on the codebook entry indication, where the codebook is based on a matrix formed by multiplication of a first component matrix and a second component matrix, the first component matrix comprising discrete Fourier transform (DFT) vectors. It is noted that in the case of rank 1 precoding, the second component matrix reduces to a vector (e.g., a 4-element vector). In an embodiment, a codebook entry is accessed in codebook 320, where codebook 320 contains precoder matrices such as those described above.

In step 430, transmissions for the MIMO system are performed using said codebook entry. In an embodiment, the codebook entry from codebook 320 corresponding to a transmit precoder vector or matrix is applied to the data before transmission via antennas 106A through 106D.

At step 440, method 400 ends.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

The claims in the instant application are different than those of the parent application or other related applications. The Applicant therefore rescinds any disclaimer of claim scope made in the parent application or any predecessor application in relation to the instant application. The Examiner is therefore advised that any such previous disclaimer and the cited references that it was made to avoid, may need to be revisited. Further, the Examiner is also reminded that any disclaimer made in the instant application should not be read into or against the parent application.

What is claimed is:

1. A method, comprising:
receiving, at a first communication device, a codebook entry indication from a second communication device, wherein the first communication device communicates with the second communication device via a channel, the first communication device including a four-antenna array selected from a uniform linear antenna array, a cross-polarized antenna array and an uncorrelated antenna array;
accessing a codebook entry, using the codebook entry indication, in a codebook related to a multiple input multiple output (MIMO) system, the codebook being stored in a memory and having entries for rank 1 through 4, wherein the codebook is based on a matrix formed by multiplication of a first component matrix and a second component matrix, the first component matrix comprising discrete Fourier transform (DFT) vectors; and
performing transmissions by the MIMO system using said codebook entry.

2. The method of claim 1, wherein the discrete Fourier transform (DFT) vectors are associated with an angle of departure of a dominant signal path from the four-antenna array.

3. The method of claim 1, wherein the second component matrix includes a use of a unary sign operator, the unary sign operator supporting channel characteristics associated with closely-spaced cross-polarized antennas or widely-spaced cross-polarized antennas.

4. The method of claim 1, wherein the first component matrix, is a 4×4 diagonal matrix, and the second component matrix is a 4×r matrix that captures refined channel characteristics, the refined channel characteristics including a difference in channel characteristics between two uniform linear antenna arrays, or a difference between the overall precoder and the first component matrix for highly correlated channels, and wherein r is an integer greater than or equal to one.

5. The method of claim 1, wherein the first component matrix is given by diag(v), where v is given by:
$$v ∈ \{ \frac{1}{2} [ \begin{matrix}1 & {e}^{j \frac{2 π {n}_{1}}{{2}^{{B}_{1}}}} & {e}^{j2 \frac{2 π {n}_{1}}{{2}^{{B}_{1}}}} & {e}^{j3 \frac{2 π {n}_{1}}{{2}^{{B}_{1}}}}\end{matrix} ] , {n}_{1} = 0 , … , {2}^{{B}_{1}} - 1 \} ,$$
B₁ is a number of bits available to quantize the first component matrix, and wherein the second component matrix is given by:
W_{w}1/\sqrt{r}×Mᵣ
where r is a rank associated with the transmissions, and for r equal to 1:
$${M}_{r} = [ \begin{matrix}1 \\ 1 \\ {e}^{j \frac{2 π {n}_{2}}{{2}^{{B}_{1} - 1}}} \\ {αe}^{j \frac{2 π {n}_{2}}{{2}^{{B}_{1} - 1}}}\end{matrix} ] , \\ {n}_{2} = 0 , … , {2}^{{B}_{1} - 1} - 1 , α = \pm 1.$$

6. The method of claim 1, wherein the first component matrix is a block-diagonal matrix, and the second component matrix includes a selection vector to select incremental beam adjustments associated with the discrete Fourier transform (DFT) vectors.

7. The method of claim 1, wherein the first component matrix is given by:
$${W}_{1} = [ \begin{matrix}{X}_{n} & 0 \\ 0 & {X}_{n}\end{matrix} ]$$
$$where$$
$$n = 0 , 1 , … , 15$$
$${X}_{n} = [ \begin{matrix}1 & 1 & 1 & 1 \\ {q}_{1}^{n} & {q}_{1}^{n + 8} & {q}_{1}^{n + 16} & {q}_{1}^{n + 24}\end{matrix} ]$$
$$where$$
$${q}_{1} = {e}^{j 2 π / 32}$$
and the second component matrix is given by, for a rank of 1:
$${W}_{2 , n} ∈ \{ \frac{1}{\sqrt{2}} [ \begin{matrix}Y \\ α ( i ) Y\end{matrix} ] , \frac{1}{\sqrt{2}} [ \begin{matrix}Y \\ j α ( i ) Y\end{matrix} ] , \frac{1}{\sqrt{2}} [ \begin{matrix}Y \\ - α ( i ) Y\end{matrix} ] , \frac{1}{\sqrt{2}} [ \begin{matrix}Y \\ - jα ( i ) Y\end{matrix} ] \}$$
$$and$$
$$Y = {e}_{i} ∈ \{ {e}_{1} , {e}_{2} , {e}_{3} , {e}_{4} \} \\ and \\ α ( i ) = {q}_{1}^{2 ( i - 1 )} ;$$
and eᵢ a selection vector of zeroes and a “1” in the i^{th} row.

8. The method of claim 1, wherein the first component matrix is given by:
$${W}_{1} = [ \begin{matrix}{X}_{n} & 0 \\ 0 & {X}_{n}\end{matrix} ]$$
$$where$$
$$n = 0 , 1 , … , 15$$
$${X}_{n} = [ \begin{matrix}1 & 1 & 1 & 1 \\ {q}_{1}^{n} & {q}_{1}^{n + 8} & {q}_{1}^{n + 16} & {q}_{1}^{n + 24}\end{matrix} ]$$
$$where$$
$${q}_{1} = {e}^{j 2 π / 32}$$
and the second component matrix is given by, for a rank of 2:
$${W}_{2 , n} ∈ \{ \frac{1}{2} [ \begin{matrix}{Y}_{1} & {Y}_{2} \\ {Y}_{1} & - {Y}_{2}\end{matrix} ] , \frac{1}{2} [ \begin{matrix}{Y}_{1} & {Y}_{2} \\ j {Y}_{1} & - j {Y}_{2}\end{matrix} ] \} ( {Y}_{1} , {Y}_{2} ) ∈ \{ ( {e}_{1} , {e}_{1} ) , ( {e}_{2} , {e}_{2} ) , ( {e}_{3} , {e}_{3} ) , ( {e}_{4} , {e}_{4} ) \}$$
$$and$$
$${W}_{2 , n} ∈ \{ \frac{1}{2} [ \begin{matrix}{Y}_{1} & {Y}_{2} \\ {Y}_{2} & - {Y}_{1}\end{matrix} ] , \} ( {Y}_{1} , {Y}_{2} ) ∈ \{ ( {e}_{1} , {e}_{3} ) , ( {e}_{2} , {e}_{4} ) , ( {e}_{3} , {e}_{1} ) , ( {e}_{4} , {e}_{2} ) \}$$
and eᵢ a selection vector of zeroes and a “1” in the i^{th} row.

9. The method of claim 1, wherein the first component matrix is configured to compensate for a long term or a wideband variation of channel characteristics.

10. The method of claim 1, wherein the second component matrix is configured to compensate for a short term or a narrowband variation of channel characteristics.

11. A communication device, comprising:
a processor and/or circuit configured to:
receive a codebook entry indication from a second communication device, wherein the communication device communicates with the second communication device via a channel, the communication device including a four-antenna array selected from a uniform linear antenna array, a cross-polarized antenna array and an uncorrelated antenna array;
access a codebook entry, using the codebook entry indication, in a codebook related to a multiple input multiple output (MIMO) system, the codebook being stored in a memory and having entries for rank 1 through 4, wherein the codebook is based on a matrix formed by multiplication of a first component matrix and a second component matrix, the first component matrix comprising discrete Fourier transform (DFT) vectors; and
perform transmissions by the MIMO system using said codebook entry.

12. The communication device of claim 11, wherein the discrete Fourier transform (DFT) vectors are associated with an angle of departure of a dominant signal path from the four-antenna array.

13. The communication device of claim 11, wherein the second component matrix includes a use of a unary sign operator, the unary sign operator supporting channel characteristics associated with closely-spaced cross-polarized antennas or widely-spaced cross-polarized antennas.

14. The communication device of claim 11, wherein the first component matrix is a 4×4 diagonal matrix, and the second component matrix is a 4×r matrix that captures refined channel characteristics, the refined channel characteristics including a difference in channel characteristics between two uniform linear antenna arrays, or a difference between the overall precoder and the first component matrix for highly correlated channels, and wherein r is an integer greater than or equal to one.

15. The communication device of claim 11, wherein the first component matrix is given by diag(v), where v is given by:
$$v ∈ \{ \frac{1}{2} [ \begin{matrix}1 & {e}^{j \frac{2 π {n}_{1}}{{2}^{{B}_{1}}}} & {e}^{j2 \frac{2 π {n}_{1}}{{2}^{{B}_{1}}}} & {e}^{j3 \frac{2 π {n}_{1}}{{2}^{{B}_{1}}}}\end{matrix} ] , {n}_{1} = 0 , … , {2}^{{B}_{1}} - 1 \} ,$$
B₁ is a number of bits available to quantize the first component matrix, and wherein the second component matrix is given by:
W₂=1/\sqrt{r}×Mᵣ
where r is a rank associated with the transmissions, and for r equal to 1:
$${M}_{r} = [ \begin{matrix}1 \\ 1 \\ {e}^{j \frac{2 π {n}_{2}}{{2}^{{B}_{1} - 1}}} \\ {αe}^{j \frac{2 π {n}_{2}}{{2}^{{B}_{1} - 1}}}\end{matrix} ] , \\ {n}_{2} = 0 , … , {2}^{{B}_{1} - 1} - 1 , α = \pm 1.$$

16. The communication device of claim 11, wherein the first component matrix is a block-diagonal matrix, and the second component matrix includes a selection vector to select incremental beam adjustments associated with the discrete Fourier transform (DFT) vectors.

17. The communication device of claim 11, wherein the first component matrix is given by:
$${W}_{1} = [ \begin{matrix}{X}_{n} & 0 \\ 0 & {X}_{n}\end{matrix} ]$$
$$where$$
$$n = 0 , 1 , … , 15$$
$${X}_{n} = [ \begin{matrix}1 & 1 & 1 & 1 \\ {q}_{1}^{n} & {q}_{1}^{n + 8} & {q}_{1}^{n + 16} & {q}_{1}^{n + 24}\end{matrix} ]$$
$$where$$
$${q}_{1} = {e}^{j 2 π / 32}$$
and the second component matrix is given by, for a rank of 1:
$${W}_{2 , n} ∈ \{ \frac{1}{\sqrt{2}} [ \begin{matrix}Y \\ α ( i ) Y\end{matrix} ] , \frac{1}{\sqrt{2}} [ \begin{matrix}Y \\ j α ( i ) Y\end{matrix} ] , \frac{1}{\sqrt{2}} [ \begin{matrix}Y \\ - α ( i ) Y\end{matrix} ] , \frac{1}{\sqrt{2}} [ \begin{matrix}Y \\ - jα ( i ) Y\end{matrix} ] \}$$
$$and$$
$$Y = {e}_{i} ∈ \{ {e}_{1} , {e}_{2} , {e}_{3} , {e}_{4} \} \\ and \\ α ( i ) = {q}_{1}^{2 ( i - 1 )} ;$$
and eᵢ a selection vector of zeroes and a “1” in the i^{th} row.

18. The communication device of claim 11, wherein the first component matrix is given by:
$${W}_{1} = [ \begin{matrix}{X}_{n} & 0 \\ 0 & {X}_{n}\end{matrix} ]$$
$$where$$
$$n = 0 , 1 , … , 15$$
$${X}_{n} = [ \begin{matrix}1 & 1 & 1 & 1 \\ {q}_{1}^{n} & {q}_{1}^{n + 8} & {q}_{1}^{n + 16} & {q}_{1}^{n + 24}\end{matrix} ]$$
$$where$$
$${q}_{1} = {e}^{j 2 π / 32}$$
and the second component matrix is given by, for a rank of 2:
$${W}_{2 , n} ∈ \{ \frac{1}{2} [ \begin{matrix}{Y}_{1} & {Y}_{2} \\ {Y}_{1} & - {Y}_{2}\end{matrix} ] , \frac{1}{2} [ \begin{matrix}{Y}_{1} & {Y}_{2} \\ j {Y}_{1} & - j {Y}_{2}\end{matrix} ] \} ( {Y}_{1} , {Y}_{2} ) ∈ \{ ( {e}_{1} , {e}_{1} ) , ( {e}_{2} , {e}_{2} ) , ( {e}_{3} , {e}_{3} ) , ( {e}_{4} , {e}_{4} ) \}$$
$$and$$
$${W}_{2 , n} ∈ \{ \frac{1}{2} [ \begin{matrix}{Y}_{1} & {Y}_{2} \\ {Y}_{2} & - {Y}_{1}\end{matrix} ] , \} ( {Y}_{1} , {Y}_{2} ) ∈ \{ ( {e}_{1} , {e}_{3} ) , ( {e}_{2} , {e}_{4} ) , ( {e}_{3} , {e}_{1} ) , ( {e}_{4} , {e}_{2} ) \}$$
and eᵢ a selection vector of zeroes and a “1” in the i^{th} row.

19. The communication device of claim 11, wherein the first component matrix is configured to compensate for a long term or a wideband variation of channel characteristics.

20. The communication device of claim 11, wherein the second component matrix is configured to compensate for a short term or a narrowband variation of channel characteristics.
